(19) United States
(12) Patent Application Publication
(10) Pub. No.: US 2003/0005416 A1
(43) Pub. Date: Jan. 2, 2003

(54) Fault search method and apparatus

(76) Inventors: Renate Henftling, Fuerstenfeldbruck (DE); Wolfgang Ecker, Muenchen (DE); Andreas Zinn, Muenchen (DE); Matthias Bauer, Otterfing (DE); Martin Zambaldi, Muenchen (DE)

Correspondence Address: MARSHALL, GERSTEIN & BORUN, 6300 SEARS TOWER, 233 SOUTH WACKER, CHICAGO, IL, 60606-6357, US

(21) Appl. No.: 10/162,358

(22) Filed: Jun. 4, 2002

(30) Foreign Application Priority Data
Jun. 5, 2001 (DE) 101 27 170.0

(51) Int. Cl. G06F 9/44

(52) U.S. Cl. 717/129

(57) ABSTRACT

A fault search method and apparatus for simplified use and control of fault search in a system with several different models such as, for example, a hardware model, a software program and a test bench model. A user activates a uniform debugger, which, in turn, retrieves and executes various subordinate debuggers that are each allocated to a different model. The subordinate debuggers then access the different models allocated to them for the performance of corresponding fault search operations.

### BACKGROUND

1. Field

The present invention relates to a fault search method for a system with different simulation models such as, for example, a hardware model, a software program and/or a test bench model, and a device for fault search in a system with such different simulation models which can preferably be used in hardware design, such as in the design of electronic circuits (i.e., in this case the system to be simulated is an electronic circuit).

2. Related Art

There are systems to be simulated in which, by means of a controlled and instrumented processing of program steps (known as debugging) in a test environment, faults are sought and simulated by various simulation models. In the context of this application, the term “simulation model” includes, in particular, hardware models, software programs and test bench models. Such a system can be described for example using three classes of language: with one or more hardware description languages (HDL) for hardware; one or more programming languages (PL) for software; and a test language (TL) or hardware verification language (HVL) for the test bench.

When fault searching in data processing programs, usually the model or program to be examined for faults is executed under the control of a fault search facility or fault search program known as a debugger. Here the fault search program is retrieved, which, in turn, retrieves the model or program to be examined which usually contains an interrupt point. When this interrupt point is reached the further processing of the program to be examined is stopped and the debugger is run back.

In conventional fault search processes for each class of the above languages, i.e., for each model, a separate fault search program with its own commands and interface is used. The advantage that for each class of language an optimum debugger can be used, is balanced against the disadvantage that the various debuggers for the different models behave differently and the user must monitor many command interfaces and windows on the screen of his computer workstation.

### SUMMARY

A fault search method is disclosed for a system simulated by several different simulation models, where the system is described in individual simulation models by description languages of different classes, and where allocated to the individual simulation models are different first fault search facilities for tracing a fault in each case by means of access to the corresponding simulation model. The method includes automatically detecting a user input using a second fault search facility which is of a higher order than the first fault search facilities. Also, the method includes automatically controlling the first fault search facilities by the second fault search facility depending on the user input, in order to find a system fault by access to a relevant simulation model.

An apparatus is disclosed for fault searching for a system simulated by a plurality of different simulation models, wherein the system is described in the individual simulation model by description languages of different classes. The apparatus includes a plurality of first fault search facilities each allocated to a corresponding simulation model to find a system fault by access to the corresponding simulation model. A second fault search facility that is of a higher order than each of the plurality of first fault search facilities is also provided wherein the second fault search facility is configured to automatically detect a user input and control the first fault search facilities as a function of the user input to find a fault by access to relevant simulation models.

### BRIEF DESCRIPTION OF THE DRAWINGS

FIG. 1 illustrates a diagrammatic view of a structure of a device for fault search according to the teachings of the present invention.

FIG. 2 illustrates a diagrammatic view of another structure of a device for fault search according to the teachings of the present invention.

FIG. 3 is a flow diagram illustrative of a function procedure for a fault search method.

FIG. 4 is a flow diagram illustrative of a further function procedure of a fault search method.

FIG. 5 is a flow diagram to explain another further function procedure of a fault search method according to the present invention.

### DETAILED DESCRIPTION OF THE PREFERRED EXAMPLES

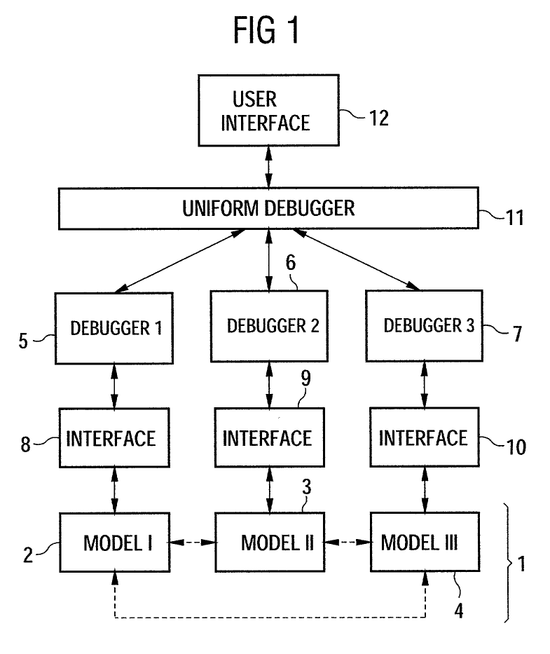

FIG. 1 shows a structure of a device for performance of a fault search method. Here, a system 1 to be simulated is constructed from three different simulation models 2-4, referred to below for the sake of simplicity as the model. The models 2, 3, 4 (marked I to III in FIG. 1) are, for example, a hardware model, a software model/program and a test bench model in which the system is described by the corresponding languages as initially explained. Furthermore the different models 2, 3, 4 present in stored form usually communicate with each other. The number of models or classes of language used is not established, where only two languages, e.g., a hardware description language and a test language, can be used, i.e., it is in particular also possible to simulate a system comprising just a hardware model and a software program and search this for faults.

All models 2, 3, 4 of system 1 to be simulated have a corresponding interface 8, 9, 1 0 to a fault search facility specially matched to the model concerned, in the form of debuggers 5 to 7, i.e., each model 2, 3, 4 is provided with an optimum debugger with its own different commands.

In contrast to conventional fault search devices, with the presently disclosed fault search device the user need not work with and control several different special debuggers 5-7. Rather the user has access to a higher order fault search facility in the form of a uniform debugger 11 which the user can use via a suitable user interface 12. This uniform debugger 11 has its own command interpreter with its own commands and, where applicable, its own graphic interface. This command interpreter converts its own commands into the relevant commands of the various special debuggers 5, 6 and 7 and supplies the converted commands to the individual special debuggers 5, 6 and 7 for processing the corresponding fault search operations by access to the model concerned. Conversely, the command interpreter of the uniform debugger 11 converts the commands or outputs and feedback supplied by the various special debuggers 5, 6 and 7 such that they can be output to the user and shown in a standard form via the user interface 12.

In the fault search device according to this embodiment the user need not, as in former systems, control several debuggers 5-7 in parallel. Instead, the user operates or controls only the uniform debugger 11. Thus the performance of fault search is considerably simplified for the user.

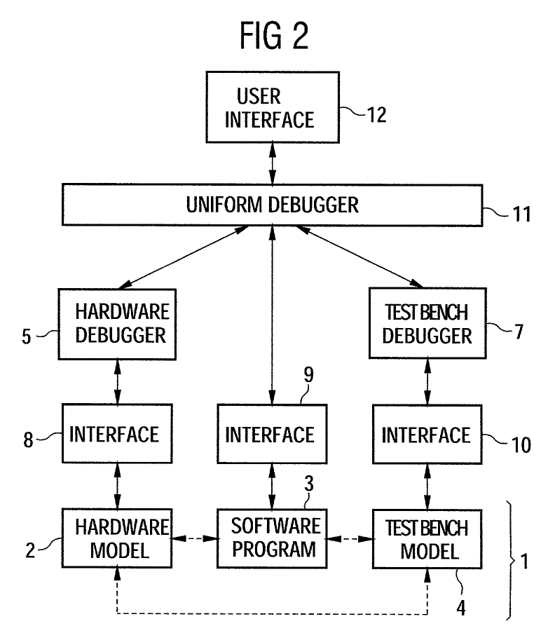

An alternative example of a fault search device is shown in FIG. 2. The same components of this arrangement carry the same reference figures as in the example of FIG. 1.

The second example differs from the example shown in FIG. 1 in that the special debugger 6 for the software program 3 is omitted. This means that the uniform debugger 11 in this case accesses the debugger interface 9 of the software program 3 directly for control and analysis. In the UNIX operating system the term “common object format” is used in connection with such a debugger interface 9. For the case where such general interfaces 8 or 10 are provided in relation to the hardware model 2 and/or the test bench model 4, in the same way the hardware debugger 5 and the test bench debugger 7 can be omitted as the uniform debugger 11 can act directly on the hardware model 2 or the test bench model 4.

Communication between the uniform debugger 11 and the special subordinate debuggers 5, 6 and 7 used in both disclosed examples of the fault search device is preferably based on a so-called “master-slave” communication. Throughout the entire simulation, the uniform debugger 11 acts as master whereas the individual special debuggers 5, 6 and 7 work as slaves. Thus each inquiry from the uniform debugger 11 to one of the debuggers 5, 6 and 7 used is acknowledged by this with a confirmation. Such a confirmation can, for example, be merely a prompt, i.e., a renewed input request by the debugger 5-7 concerned. In addition to this confirmation, if required, e.g., if the higher order uniform debugger 11 gives a command to a subordinate special debugger 5-7 to calculate the value of an object, the special debugger 5, 6, 7 concerned feeds back to the uniform debugger 11 further information such as, for example, the value of this object. Thus, communication between the uniform debugger 11 and the special debuggers 5-7 is fully automated and computer-supported, i.e., the uniform debugger 11 automatically detects a user input and converts this into a corresponding trigger/activation of the special debuggers 5-7, which, in turn, perform the corresponding fault search operations automatically with computer support.

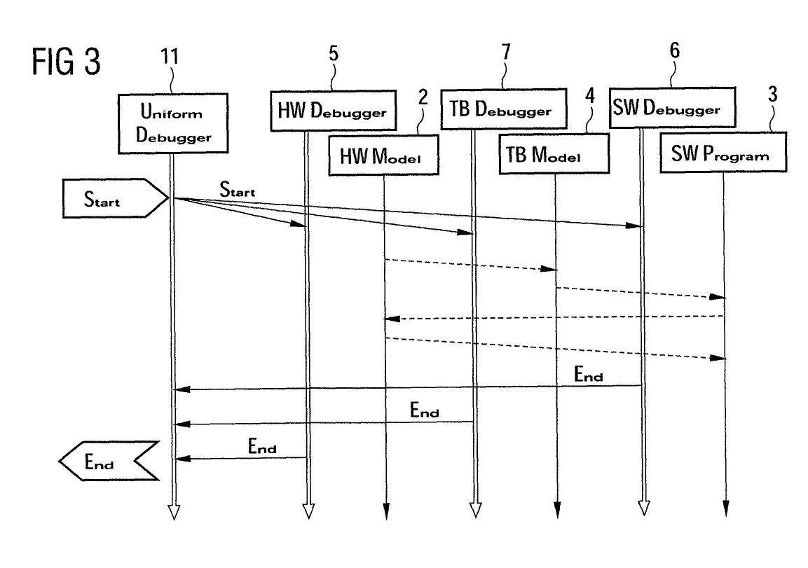

Using FIGS. 3-5, as examples, various function procedures are now explained which can occur in a fault search method with the fault search devices described above. It will be evident to a person skilled in the art that the presently disclosed fault search method is not restricted to the function procedures in FIGS. 3-5, but these serve merely for better understanding of the invention and the person skilled in the art will automatically be able to transfer the structure disclosed to further function procedures which are required for fault search in systems with several different models.

FIG. 3 shows first the function procedures for a command which is sent by the uniform debugger 11 to all available special debuggers 5-7. In the example shown, the user, via the user interface 12, gives the command “start” to the uniform debugger 11, for example. The uniform or main debugger 11 converts the “start” command into the equivalent command for the special debuggers 5, 6, 7 such as, for example, “run” or “start” and passes these converted commands to the individual special debuggers 5, 6 and 7. As in the case shown in FIG. 1, as special subordinate debuggers are used a hardware (HW) debugger 5 with access to a hardware (HW) model 2, a software (SW) debugger 6 with access to a software (SW) program/model 3, and a test bench (TB) debugger 7 with access to a test bench (TB) model 4.

After all debuggers 5, 6, 7, because of the start command supplied by the uniform debugger 11, have begun processing their models or programs 2, 3, 4, usually a random sequence of interactions takes place between the models or programs as indicated in FIG. 3 by arrows. When the execution of models 2, 3 and 4 has ended, the allocated debuggers 5, 6, 7 each send a specific “end” message to the uniform debugger 11, where these “end” messages may also be correlated. The main fault search program 11 then converts these “end” messages and outputs a corresponding “end” feedback to the user interface 12.

To administer all objects involved in the simulation of system 1 the uniform debugger 11 must combine the objects of all models 2, 3 and 4. This means that different name ranges (hardware, software, test bench) must be administered together. As in principle it is possible, for example, for a variable of the software program 3 to have the same name as a signal of the hardware model 2, it is advantageous if the uniform debugger 11 is able to expand the local name ranges of the individual models 2, 3 and 4 internally into global names in order to distinguish them.

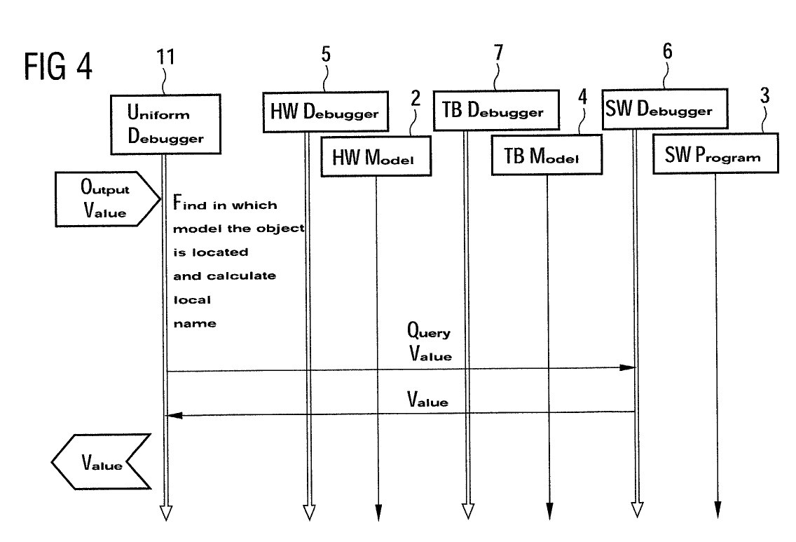

With reference to FIG. 4 the function procedure is now explained for a command entered by the user to query the value of an object of a particular model. First the uniform debugger 11, using the global object name for which the value is to be checked, must determine in which model 2, 3 and 4 the required object is present. Then the uniform debugger 11 determines the corresponding local name of the object and by means of a corresponding command requests the value of the object from the relevant subordinate special debugger (in the present case the software debugger 6) under whose control the specific model 3, to which the object belongs, is running. The special debugger 6 gives the required value of the object back to the uniform debugger 11 which passes on this value, where applicable after further processing, to the user interface 12.

In a similar way, interrupt conditions can be set or deleted by the user or object values set. In such cases the relevant special debugger 5, 6 and 7, instead of returning the value of the object as described above, will return merely a confirmation to the uniform debugger 11.

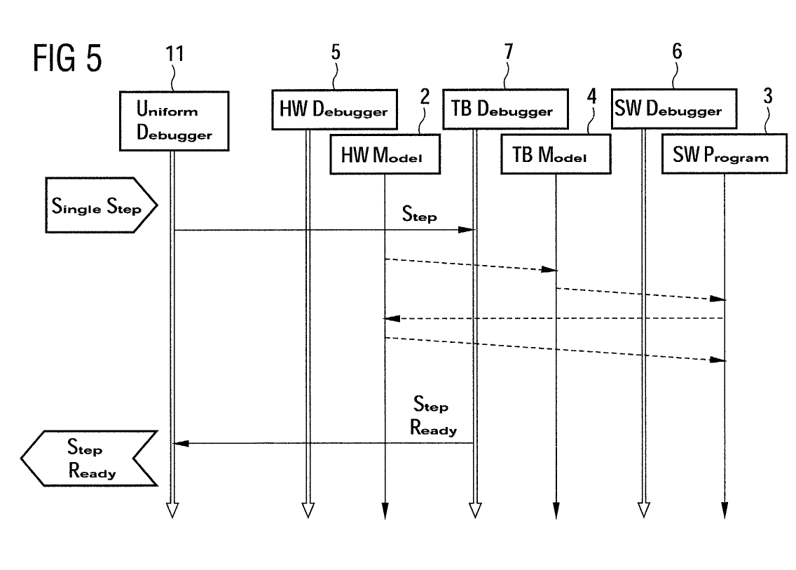

Finally as a third example of a function procedure, FIG. 5 shows the processing of a single step command. On the basis of a single step command entered by the user via the user interface 12, the uniform debugger 11 generates a corresponding single step command for the desired model (in the present case the test bench model 4) and passes this to the debugger 7 allocated to the model 4. Then the model 4 is operated in single step mode while the other models 2, 3 can run without interruption and not in single step mode. On completion of the single step, the debugger 7 sends a confirmation that the single step of model 4 is completed back to the uniform debugger 11, which converts this confirmation into a corresponding command for the user interface 12.

In the function processes described above it is generally irrelevant whether a single step proceeds via a single individual instruction or via several combined single instructions. Also the single step command, depending on the user command, can apply both to one model and to several or all models 2, 3, 4.

The presently disclosed processes and devices provide a fault search method for a system with different simulation models that is easy for the user to use and control. This is accomplished by a fault search in a system with several different simulation models such as for example a hardware model, a software model/program and a test bench model, the user executes a higher order fault search facility (debugger), which, in turn, communicates with and activates various subordinate fault search facilities (debuggers) each allocated to a different simulation model. Each subordinate fault search facility has access to its allocated simulation model in order to trace a fault in the system (or in the simulation model concerned). By providing the higher order, uniform and common fault search facility, the user has access to a uniform interface with its own commands, own command interpreter and own interface to simplify fault searching in the individual simulation models for the user. At the same time optimum debuggers for the various simulation models can be used as subordinate fault search facilities so that despite the simplified operation for the user, optimum results of the fault search can be guaranteed. Additionally, the higher order fault search facility can intervene directly, i.e. without the intermediary of a corresponding subordinate fault search facility, on the simulation model concerned for control and analysis. Communication takes place preferably between the uniform higher order fault search facility and the individual subordinate and special fault search facilities in the form of a master worker or master slave communication, where the higher order fault search facility acts as the master and the subordinate fault search facilities act as workers or slaves.

Although certain methods and apparatuses in accordance with the teachings of the invention have been described herein, the scope of coverage of this patent is not limited thereto. On the contrary, this patent covers all embodiments of the teachings of the invention fairly falling within the scope of the appended claims either literally or under the doctrine of equivalents.

What is claimed is:

1. A fault search method for a system simulated by several different simulation models, where the system is described in individual simulation models by description languages of different classes, and where allocated to the individual simulation models are different first fault search facilities for tracing a fault in each case by means of access to the corresponding simulation model, the method comprising:
automatically detecting a user input using a second fault search facility which is of a higher order than the first fault search facilities, and
automatically controlling the first fault search facilities by the second fault search facility depending on the user input, in order to find a system fault by access to a relevant simulation model.

2. A fault search method according to claim 1, wherein one simulation model is a hardware simulation model in which the system is described by a hardware description language, and a hardware debugger is allocated to the one simulation model as a corresponding first fault search facility.

3. A fault search method according to claim 1, wherein one simulation model is a test bench simulation model in which the system is described by a test bench language, and a test bench debugger is allocated to the one simulation model as a corresponding first fault search facility.

4. A fault search method according to claim 1, wherein one simulation model is a software simulation model in which the system is described by a programming language, and a software debugger is allocated to the one simulation model as a corresponding first fault search facility.

5. A fault search method according to claim 1, wherein the higher order second fault search facility accesses at least one simulation model directly without the intervention of a first fault search facility.

6. A fault search method according to claim 1, wherein the second fault search facility automatically converts a user input into corresponding commands for the individual first fault search facilities.

7. A fault search method according to claim 1, wherein the first fault search facility automatically, as a function of the control by the second fault search facility, performs a corresponding fault search operation by access to the relevant simulation model, and wherein the second fault search facility automatically detects and outputs to the user feedback generated by the individual first fault search facilities during a relevant fault operation.

8. A fault search method according to claim 1, wherein communication between the second fault search facility and the first fault search facilities takes place in the form of a master-slave communication, where the second fault search facility acts as a master and the first fault search facilities act as slaves.

9. An apparatus for fault searching for a system simulated by a plurality of different simulation models, wherein the system is described in the individual simulation model by description languages of different classes, the apparatus comprising:
a plurality of first fault search facilities each allocated to a corresponding simulation model to find a system fault by access to the corresponding simulation model; and
a second fault search facility that is of a higher order than each of the plurality of first fault search facilities;
wherein the second fault search facility is configured to automatically detect a user input and control the first fault search facilities as a function of the user input to find a fault by access to relevant simulation models.

10. An apparatus according to claim 9, wherein one simulation model of the plurality of different simulation models is a hardware simulation model in which the system is described by a hardware description language, and a hardware debugger is allocated to the one simulation model as a corresponding first fault search facility.

11. An apparatus according to claim 9, wherein one simulation model of the plurality of different simulation models is a test bench simulation model in which the system is described by a test bench language, and a test bench debugger is allocated to the one simulation model as a corresponding first fault search facility.

12. An apparatus according to claim 9, wherein one simulation model of the plurality of different simulation models is a software simulation model in which the system is described by a programming language, and a software debugger is allocated to the one simulation model as a corresponding first fault search facility.

13. An apparatus according to claim 9, wherein the second fault search facility acts directly on at least one simulation model without the intervention of a corresponding first fault search facility.

14. An apparatus according to claim 9, wherein the second fault search facility is designed for automatic conversion of the user input into corresponding commands for the individual first fault search facilities.

15. An apparatus according to claim 9, wherein the individual fault search facilities are configured for automatic performance of corresponding fault search operations in accordance with the control by the second fault search facility by access to a relevant simulation model, and that the second fault search facility is configured for automatic detection and output to the user of feedback generated by the first fault search facilities during the respective fault search operations.

16. An apparatus according to claim 9, wherein the individual first fault search facilities and the second fault search facility are configured to perform a master-slave communication between the first fault search facility as the master on one side and the individual second fault search facilities as slaves on the other.

17. An apparatus according to claim 9, wherein an interface for connection to the relevant first fault search facility is respectively allocated to each of the individual simulation models.

18. An apparatus according to claim 9, wherein the individual simulation models comprise facilities designed for mutual communication.

19. An apparatus according to claim 9, wherein the apparatus is utilized for the design of electronic circuits.
